(19) United States
(12) Patent Application Publication
(10) Pub. No.: US 2026/0109261 A1
(43) Pub. Date: Apr. 23, 2026

(54) EVTOL BATTERY MANAGEMENT WITH RESERVOIR COMPUTING

(71) Applicant: TOYOTA MOTOR ENGINEERING & MANUFACTURING NORTH AMERICA, INC., Plano, TX (US)

(72) Inventors: ROHIT GUPTA, Santa Clara, CA (US); Akila C. Ganlath, Fremont, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/924,257

(22) Filed: Oct. 23, 2024

(51) Int. Cl. B60L 58/12; B64D 27/357; H01M 10/42

(52) U.S. Cl. CPC B60L 58/12; B64D 27/34; B64D 27/357; H01M 10/425; B60L 2200/10; H01M 2010/4271; H01M 2220/20

(57) ABSTRACT

Systems and methods are provided for managing batteries for electrical vehicles utilizing varying power amounts. For example, a presently disclosed electric vehicle may comprise: (1) a battery providing electrical power for operation of the electric vehicle, wherein the operation of the electric vehicle comprises multiple phases that require a different amount of electrical power; and (2) one or more processors configured to: (a) predict one or more parameters associated with performance of the battery during the multiple phases for current operation of the electric vehicle, wherein the prediction is based on a machine learning model trained on data associated with performance of the battery during the multiple phases for previous operation of the electric vehicle; and (b) based on the prediction, dynamically adjust electrical power provided by the battery during one of the multiple stages for the current operation of the electric vehicle to manage the one or more parameters.

### TECHNICAL FIELD

The present disclosure relates generally to battery management for electrical vehicles utilizing varying amounts of power rather than steady-state battery drainage, such as electric Vertical Takeoff and Landing vehicles (eVTOLS). Battery management can include using machine learning techniques, such as reservoir computing (RC).

### DESCRIPTION OF RELATED ART

Electrical Vertical Take-Off and Landing Vehicles (eVTOLs) are a class of aircraft that use electrical power to take off, hover, and land vertically, much like a helicopter. They are a part of a broader push toward cleaner, more sustainable transportation systems, especially in urban environments. Many eVTOLs are typically powered by batteries or hybrid electrical systems, and they often incorporate multiple rotors or tilt-rotor technology, which allows them to transition between vertical takeoff and horizontal flight efficiency. The eVTOL market is expected to grow significantly in the coming years, with a predicted shift from pilot-generated aircraft to fully autonomous flight. As the technology continues to advance, the first commercial passenger services utilizing eVTOLs may begin to emerge and expand the presence of eVTOLs in the real-world.

Unlike some electric vehicle (EV) batteries, which typically drain at a steady rate, eVTOL batteries need varying amounts of power for flight stages such as climbing, hovering and descent, with some phases requiring high bursts of power. In many cases, eVTOLs require batteries that can handle exceptionally high discharge rates for operations like takeoff and landing. It may be advantageous to implement techniques and systems that address these dynamic battery management issues that may be experienced in the realm of eVTOL technology.

### BRIEF SUMMARY OF THE DISCLOSURE

In accordance with one embodiment, various embodiments of the presently disclosed technology an electric vehicle is provided. The electric vehicle may comprise: (1) a battery providing electrical power for operation of the electric vehicle, wherein the operation of the electric vehicle comprises multiple phases that require a different amount of electrical power; and (2) one or more processors configured to: (a) predict one or more parameters associated with performance of the battery during the multiple phases for current operation of the electric vehicle, wherein the prediction is based on a machine learning model trained on data associated with performance of the battery during the multiple phases for previous operation of the electric vehicle; and (b) based on the prediction, dynamically adjust electrical power provided by the battery during one of the multiple stages for the current operation of the electric vehicle to manage the one or more parameters.

In some embodiments of the electric vehicle, the electric vehicle may comprise an electric Vertical Takeoff and Landing vehicle (eVOTL). In some of these embodiments, the multiple phases of operation may comprise: take-off, hovering, flight, and landing. Relatedly, in certain of these embodiments the one or more processors may be further configured to dynamically adjust functions related to the current operation of the eVOTL in real-time based on the prediction. In some of the embodiments, functions related to the current operation of the eVOTL may comprise: planning energy usage, optimizing flight paths for energy efficiency, battery life management, and safety operations.

In various embodiments of the electric vehicle, the one or more parameters associated with performance of the battery may comprise: electrical power output, State of Charge (SOC), State of Health (SOH), and battery temperature.

In certain embodiments of the electric vehicle, the one or more processors may be further configured to perform fast spectral initialization, delay-state concatenation and delay-state concatenation with transient states operations on the machine learning model to manage the one or more parameters associated with performance of the battery in real-time. Here, the machine learning model may be trained in accordance with reservoir computing and received from a computer system remote from the electric vehicle. Relatedly, in some of these embodiments the one or more processors may be further configured to validate the trained machine learning model in real-time during the current operation of the electric vehicle.

In some embodiments of the presently disclosed technology non-transitory computer readable medium is provided. The non-transitory computer readable medium may comprise instructions, that when read by one or more processors, cause the one or more processors to: (1) predict one or more parameters associated with performance of a battery of an electric vehicle during multiple phases of current operation of the electric vehicle, wherein the battery provides electrical power for the current operation of the electric vehicle and the prediction is based on a machine learning model trained on data associated with the performance of the battery during the multiple phases for previous operation of the electric vehicle; and (2) based on the prediction, dynamically adjust electrical power provided by the battery during one of the multiple stages for the current operation of the electric vehicle to manage the one or more parameters.

In some embodiments of the non-transitory computer readable medium, the electric vehicle may comprise an electric Vertical Takeoff and Landing vehicle (eVOTL). Accordingly, the multiple phases of operation may comprise: take-off, hovering, flight, and landing. Relatedly, in certain of the non-transitory computer readable medium may comprise further instructions to dynamically adjust functions related to the current operation of the eVOTL in real-time based on the prediction. The functions related to the current operation of the eVOTL may comprise: planning energy usage, optimizing flight paths for energy efficiency, battery life management, and safety operations.

In certain embodiments of the non-transitory computer readable medium, the one or more parameters associated with performance of the battery may comprise: electrical power output, State of Charge (SOC), State of Health (SOH), and battery temperature.

In various embodiments of the non-transitory computer readable medium, the non-transitory computer readable medium may comprise further instructions to perform fast spectral initialization, delay-state concatenation and delay-state concatenation with transient states operations on the machine learning model to manage the one or more parameters associated with performance of the battery in real-time. Here, the machine learning model may be trained in accordance with reservoir computing and received from a computer system remote from the electric vehicle. In some of such embodiments, the non-transitory computer readable medium may comprise further instructions to validate the trained machine learning model in real-time during the current operation of the electric vehicle.

In some embodiments of the presently disclosed technology, a method is provided. The method may comprise: (1) predicting one or more parameters associated with performance of a battery of an electric vehicle during multiple phases of current operation of the electric vehicle, wherein the battery provides electrical power for the current operation of the electric vehicle and the prediction is based on a machine learning model trained on data associated with the performance of the battery during the multiple phases for previous operation of the electric vehicle; and (2) based on the prediction, dynamically adjusting electrical power provided by the battery during one of the multiple stages for the current operation of the electric vehicle to manage the one or more parameters. In certain embodiments of the method, the electric vehicle may comprise an electric Vertical Takeoff and Landing vehicle (eVOTL).

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example environment for an electric vehicle battery management system, including a controller implemented within an eVTOL for dynamic battery management of the eVTOL, according to one or more embodiments shown and described herein.

FIG. 2 is a schematic representation of another example of an electric vehicle with which embodiments of the electric vehicle battery management system disclosed herein may be implemented.

FIG. 3 depicts an example network architecture of an in-vehicle electric vehicle battery management system, in accordance with an embodiment of the technology disclosed herein.

FIG. 4 illustrates an example computing component that may be used in implementing various features of embodiments of the disclosed technology.

The figures are not exhaustive and do not limit the present disclosure to the precise form disclosed.

The figures are not exhaustive and do not limit the present disclosure to the precise form disclosed.

### DETAILED DESCRIPTION

Embodiments of the systems and methods disclosed herein implement an electrical vehicle battery management system, which distinctly leverages Reservoir Computing (RC) and machine learning (ML) capabilities to improve battery management and performance for eVTOLs, for example, which require dynamic and varying amounts of power (e.g., battery power output). In an embodiment, the electrical vehicle battery management system is a distributed system that includes elements implemented on the eVTOL itself, namely a reservoir controller, which operates cooperatively with a remote cloud-based elements in communication with the eVTOL in a manner that offloads some computational costs and processing utilization associated with RC techniques and ML model generation away from the resources of the eVTOL. Additionally, the electrical vehicle battery management system disclosed herein optimizes its RC aspects, by implementing fast spectral initialization, delay-state concatenation, and delay-state concatenation with transient states which addresses some limitations associated with RC techniques, such as a lengthy “warm up” time that is often needed to correctly predict the system.

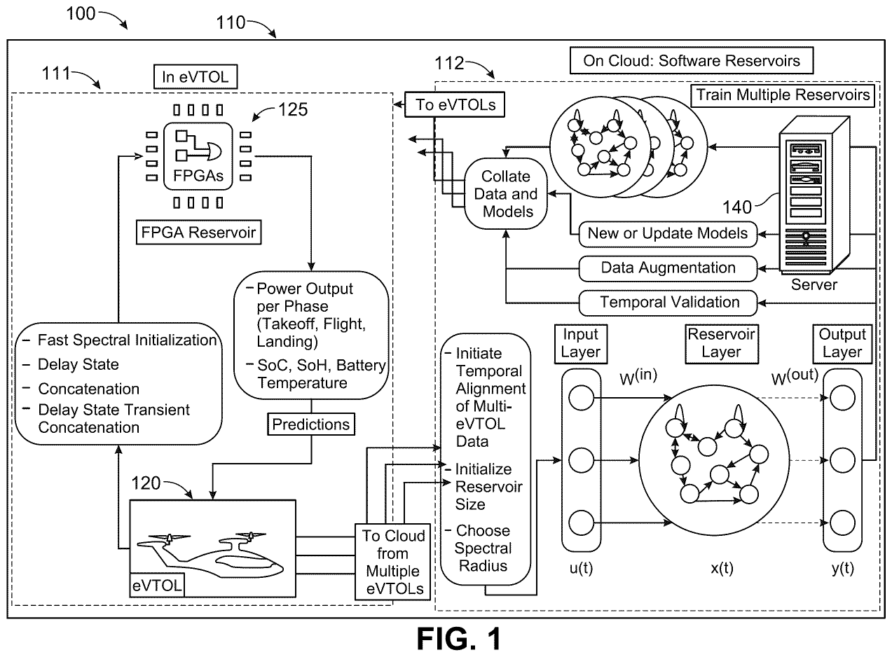

Referring now to FIG. 1, an example environment 100 is depicted, which includes an electrical vehicle battery management system 110 which implements dynamic and improved battery management for eVTOLs, in this example, which can require dynamically varying amounts of power during its different operational phases such as take-off and landing. In the example of FIG. 1, the electrical vehicle battery management system 110 is shown to comprise two communicatively coupled components that function cooperatively to implement the disclosed battery management functions, the components of the system 110 including: in-vehicle battery management components 111 which can be implemented as physical computing resource(s) of the eVTOL 120 itself; and cloud-based battery management components 112 that are implemented as a cloud-based platform having computing components and functions that are external to the eVTOL 120. In the example of FIG. 1, the eVTOL 120 may be performing a flight stage such as climbing during take-off, which requires varying and high bursts of power from its battery. The battery of the eVTOL 120 can handle exceptionally high discharge rates for operations such as takeoff and landing, and the electrical vehicle battery management system 110 is distinctly configured to utilize RC concepts in order to dynamically manage the vehicle 120's battery in a manner that adjusts the amount of power that is provided in real-time for the varying maneuvers and/or phases performed during the eVTOL's 120 operation. According to the embodiments, the electrical vehicle battery management system 110 can utilize ML models to make predictions on battery requirements and/or battery performance that may be associated with a particular phase of operation for the eVTOL 120. As a result, the system can dynamically adjust, in real-time, these battery requirement parameters (e.g., amount of power supplied by the battery) for the particular flight phase being executed by the eVTOL 120 (e.g., power output per phase), such as climbing, hovering, descent, and the like (with some phases requiring high bursts of power) in order to improve optimization of the eVTOL battery's management and its overall performance.

As described herein, the electric vehicle battery management system 110 is distinctly configured to leverage Reservoir computing (RC) which is a machine learning (ML) algorithm that can learn complex time series from data very rapidly based on the use of high-dimensional dynamical systems, such as random networks of neurons, called “reservoirs.” According to the embodiments, the electric vehicle battery management system 110 is configured to apply RC techniques to perform a plethora of eVTOL applications including, but not limited to: battery performance ML modeling, where RC can be used to create a physics-informed battery performance ML model, and the ML model can help understand the intricate interplay between power requirements, battery stability, and long-term performance; simulation of operating conditions, where RC techniques can be used to simulate the specific loads and operating conditions of eVTOL batteries. (e.g., researchers have simulated a 15C discharge pulse, a rate 15 times the battery's nominal capacity, followed by a lower-rate discharge to imitate the conditions during eVTOL operations); analysis of battery chemistry limitations, by understanding what happens to the materials under these specific loads and operating conditions, RC techniques can help figure out the limitations of the current battery chemistry; Battery Management Systems (BMS), where RC techniques can be used in the development of advanced BMS that can predict future battery states based on past and current states, improving the safety and efficiency of eVTOL operations; and predictive maintenance, by analyzing the battery's performance over time, the RC techniques can help predict when maintenance or replacement might be needed, thus preventing failures and enhancing the overall reliability of the eVTOL system. As will be described in detail throughout the disclosure, the electric vehicle battery management system 110 is configured to apply reservoir computing concepts to improve eVTOL battery management and overall performance. Although FIG. 1 shows the electric vehicle battery management system 110 operating in the environment of the eVTOL 120, it should be appreciated that the capabilities of the system 110, as disclosed herein, can be implemented in various other fully electric vehicles, hybrid vehicles, and hybrid plug-in vehicles that may require dynamic battery management such as automobiles, trucks, motorcycles, light-duty automobiles, heavy-duty and medium-duty electric vehicles, electric micro mobility devices, transit vehicles, aircraft, and the like, without departing from the scope of the embodiments.

In the example of FIG. 1, the eVTOL 120 implements the structure and functions of the reservoir controller 126 and the various other aspects of the in-vehicle battery management components 111 for the system 110, as described herein. As seen in FIG. 1, the eVTOL vehicle 120 is communicatively coupled to a cloud-based computer system 140 (shown as a server) implementing the structural and/or software elements and functions of the cloud-based battery management components 112, including ML model training, as described herein.

The eVTOL 120 can be an aircraft that uses electrical power from a battery (not shown) to perform various electrical operations such as take-off, hovering, landing vertically, and the like, much like a helicopter. As an eVTOL 120, the vehicle shown in FIG. 1 has features such as vertical take-off and landing: allowing take-off and landing in confined areas; electric propulsion, using an electric motor which results in lower emissions and potentially quieter operations than traditional gas-powered aircraft; and automation, which allows the vehicle to incorporate autonomous or semi-autonomous flight technologies. Furthermore, the in-vehicle battery management components 111 of the system 120 are configured within the eVTOL 120 as a physical on-board computer element. In the example of FIG. 1, the eVTOL 120 comprises a reservoir controller 125 that may be implemented as a hardware computer device, processor, or circuit, such as a field programmable gate array (FPGA) which is configured to enable some functions of battery management and RC processing as described herein to be performed on the vehicle.

One drawback of using reservoir computing for eVTOL battery management is that training ML models using RC techniques often require lengthy “warm up” time to correctly predict the system. This can be almost as time-consuming as the dynamic movements of the system itself. The “warm-up” issue regarding RC technique refers to the early phase where the ML model adjusts to input data, needing time to move past its initial state and adapt to input dynamics. During this phase, outputs are often unreliable and discarded because they are influenced by initial reservoir conditions. This “warm-up” poses challenges in real-time applications due to the need for immediate response and increases computational costs by requiring more data processing. Accordingly, the embodiments of the electric vehicle battery management system 110 leverage methods that mitigate the draw-backs associated with RC “warm up.” As shown in FIG. 1, the reservoir controller 125 can be particularly configured to implement fast spectral initialization, delay-state concatenation, and delay-state concatenation with transient states reducing “warm-up” in manner that optimizes the machine learning aspects of battery management for the real-time scenarios associated with eVTOL 120 operation. In some embodiments, the in-vehicle battery management components 111 can be implemented as a vehicle controller, computing hardware, software, firmware, or a combination thereof, which is programmed to perform one or more of: fast spectral initialization; delay state concatenation; delay state transient concatenation; power output per phase (e.g., take-off, landing, etc.); State of Charge (SOC); State of Health (SOH); battery temperature; and the like.

In an embodiment, the reservoir controller 125 is configured to implement fast spectral initialization functions in a manner that is efficient and overcomes the computational bottleneck related to the eigen decomposition of large matrices, thus enabling efficient large reservoir networks used in RC capabilities of the system 110. Fast spectral initialization can involve initializing a random recurrent weight matrix. For instance, the technique can start by initializing a random recurrent weight matrix, typically with values drawn from a Gaussian or uniform distribution. Subsequently, the matrix can be scaled. The matrix can then be scaled so that its largest eigenvalue (also known as the spectral radius) is approximately 1. This can be done by dividing each element of the matrix by the absolute value of the largest eigenvalue. Next, the spectral radius can be adjusted. This can be performed by multiplying the matrix by the desired spectral radius. This step adjusts the spectral radius of the matrix to the desired value without changing the direction of the eigenvectors.

Additionally, the reservoir controller 125 is configured to implement delay state concatenation and delay state concatenation with transient states functions. Delay state concatenation is a technique in RC that enhances efficiency by reducing the size of the neural reservoir. For instance, delay state concatenation can involve feeding past states of the reservoir back into the output layer at each time step, effectively increasing the dimensionality of the system and allowing it to perform well with fewer neurons. Delay state concatenation with transient states can be considered an extension of delay state concatenation, where the method includes both past and transient (or drifting) states of the reservoir in the output computation. By integrating these dynamic states, the technique increases the system's 110 dimensionality further, capturing a richer set of data dynamics and maintaining performance while reducing the reservoir size. These methods help optimize RC systems, making them more compact and computationally efficient without significant increases in error, which is crucial for practical applications. Both the delay-state concatenation and the delay-state concatenation with transient states can be particularly useful for battery management in eVTOLs, where power demands can vary significantly, especially during takeoffs and landings.

The RC related techniques implemented by the reservoir controller 125 can help capture the temporal dependencies in the battery usage data. This means the capabilities can help model how the current state of the battery (e.g., its charge level) depends not just on the immediate past, but also on the state of the battery a few time steps ago. This can be particularly useful for modeling the high-power draws during takeoffs and landings, which might depend on the state of the battery several time steps in the past. Furthermore, the RC related functions of the reservoir controller 125 enable the modeling of dynamic behavior. The eVTOL batteries exhibit dynamic behavior, especially during takeoffs and landings when power draw can change rapidly. The delay-state concatenation with transient states can help capture these dynamics by including information about transient states, which represent the short-term changes in the system. The reservoir controller 125 may also realize improved predictive performance by utilizing RC related techniques. For example, by capturing both the long-term and short-term temporal dependencies in the data, these methods can help improve the predictive performance of the model. This can lead to more accurate predictions of future battery states, which can in turn lead to more effective battery management strategies. Also, due to implementing the aforementioned RC methods, the battery control strategies of the system 110 may be more optimally informed. The improved modeling of battery behavior can inform control strategies for eVTOL operation. For instance, understanding the battery's discharge patterns during high draw periods can help in planning the energy usage, optimizing the flight paths for energy efficiency, and ensuring there's enough battery life for safe operation of the eVTOL.

The cloud-based battery management components 112 of the system are implemented as a cloud-based platform that performs RC functions and trains the ML models that are employed by the battery management features of the system 120. As a cloud-based platform, the cloud-based battery management components 112 operate as a virtual environment for performing the various artificial intelligence and/or machine learning functions that are required for executing RC techniques and implementing reservoirs for generating ML models that drive the predictive battery management capabilities of the system 110. The platform implementing the cloud-based battery management components 112 can include various hardware and/or software computing resources such as servers, databases, networking, software applications, software ML models, and other services delivered on computer networks such as the Internet. In the example of FIG. 1, the cloud-based battery management components 112 include a server 140 as a computing resource to support the computations and functions required to generate, train, update, and validate ML models as described herein. According to the embodiments, the eVTOL 120 (and other users) can access the cloud-based battery management components 112 on the cloud in order to utilize the resources on-demand and scale them as needed. As illustrated in FIG. 1, the eVTOL 140 can communicatively receive ML models, from the by the cloud-based battery management components 112, that have been trained to learn trends in battery behavior, battery requirements, and/or battery performance which were observed in eVTOLs over time. The eVTOL 140 can then employ these ML models from the “cloud” to make accurate predictions regarding its battery's performance and/or requirement parameters (e.g., power output per phase, SOC, SOH, battery temperature, etc.) in order to achieve dynamic battery management.

FIG. 1 depicts the cloud-based battery management components 112 receiving data from the eVTOL 120 (and multiple other eVTOLs) that can be used to generate, train, and update ML models for dynamic battery management. For instance, data communicated to the cloud-based battery management components 112 can be related to the changing parameters and/or measurements of the eVTOL's battery over time, for example how much power is output from the battery while the eVTOL 120 repeatedly performs its take-off phase. The cloud-based battery management components 112 are configured to take the data and initiate temporal alignment of multi-eVTOL data, initialize reservoir size, and choose spectral radius such that a training process for a neural network model can be executed.

FIG. 1 also illustrates that the cloud-based battery management components 112 can perform as training process for a neural network model in accordance with the disclosed RC techniques. Neural networks, including deep neural networks, comprise a set of processing neurons, also referred to as reservoirs, that are interconnected and weighted. In the context of neural networks and deep learning, the reservoirs can also be referred to as the “nodes” of a neural network, referring to the basic computational units within the neural network. Accordingly, reservoirs can be considered individual processing units within the neural network that receive inputs in the input layer, perform computations (including weighted summation and activation) within the reservoir layer, and produce an output in the output layer. To train the neural network, the weights of the neurons, or reservoirs, may be initially set to random values. As training data is fed to the first layer of the reservoirs, the data may pass through the next layers to transform the data to the output layer. During training, the weights and thresholds of each of the reservoirs may be adjusted until the neural network produces similar outputs for similar training data and labels. As a general description, the training phase of an untrained neural network model employed for battery management features learns from an existing training dataset, such as data related to eVTOLs'battery performance, requirements, and behavior.

As seen in the example of FIG. 1, the output from the training process for a neural network of reservoirs can be used by the cloud-based battery management components 112 to generate new ML models or update ML models, execute data augmentation, and perform temporal validation. Since several battery performance measurements, such as SOC and SOH estimation is a time-series problem, it is important to validate the ML model in a temporal setting. This means training the ML model for a certain period and then testing it against signals for some time. If performance is not met, the cloud-based battery management components 112 is configured to trigger retraining. The ML models can be retrained periodically with new data to capture the changing characteristics of the battery due to aging. This ensures that the model stays accurate throughout the lifetime of the battery. Data augmentation can involve using data from multiple different eVTOLs, where this increase in data can improve the performance of the ML model. More data can provide a more comprehensive representation of the different states an eVTOL can be in, which can lead to more accurate and robust ML models that are generated by the cloud-based battery management components 112.

The example of FIG. 1 also illustrates that the cloud-based battery management components 112 are configured to train multiple neural networks of reservoirs, or ML models, using RC techniques. The cloud-based battery management components 112 can use ensemble methods to train several reservoir computers, each with distinct parameters or starting points. The predictions from these multiple ML models are then aggregated. This aggregated approach can result in better overall performance and accuracy associated with predictions drawn from the models. The data and ML models are collated by the cloud-based battery management components 112 and communicated to the eVTOL 120, via a wireless communication network, which can then be employed to implement the dynamic battery management capabilities. For example, an ML model can be used to predict that the eVTOL 120 requires a high burst of power output from the battery during the take-off phase and then can taper off on the amount of power supplied as the eVTOL 120 reaches an altitude for its hovering phase. Thus, the battery system and other relevant components of the eVTOL 120 can be controlled by the system 110 in accordance with the inferences made based on the ML model. Continuing with the example, the system 110 can apply a control strategy that dynamically adjusts the amount of power that is output from the battery during take-off (e.g., high power output) and then adjusting to a different amount of power that is output from the battery during hovering (e.g., lower power) based on the modeled behavior (e.g., battery's discharge patterns). In accordance with the embodiments, the electric vehicle battery management system 110 can also dynamically adjust other battery performance parameters and/or states, such as SOC, SOH, and temperature, based on the RC techniques and ML model predictions, as disclosed herein. The electric vehicle battery management system 110 can employ the improved modeling of battery behavior to perform a range of functions related to eVTOL operation, including, but not limited to: planning the energy usage, optimizing the flight paths for energy efficiency; battery life management; safety operations; and the like.

In addition, the in-vehicle battery management components 111 are configured to perform operation validation. The use of RC techniques for modeling and predicting battery requirements and/or battery performance can be validated in real-time during the vehicle's operation. Operation validation can involve the in-vehicle battery management components 111 performing various functions, including: model training and testing; real-time validation; performance metrics; and the like. Regarding ML model training and testing, the ML model (generated using RC techniques) is trained using historical data on battery parameters and/or measurements such as voltage, current, temperature, and SOC. Then, the ML model can be tested with a separate dataset to confirm its ability to generalize to new, unseen data. During actual eVTOL operations the in-vehicle battery management components 111 can perform real-time validation. For example, the ML model's predictions of battery performance parameters and/or measurements can be compared with the actual battery performance measurements that are being obtained in real-time by the vehicle's Battery Management System (BMS). Battery performance parameters, such as SOC, can be obtained through methods like open-circuit voltage or ampere integration. Also, the in-vehicle battery management components 111 can assess the accuracy of the ML models using performance metrics such as Mean Absolute Error (MAE) or Root Mean Square Error (RMSE), with lower values indicating better predictive accuracy of the model. Accordingly, the electric vehicle battery management system 110 supports RC techniques and ML model predictions that are efficient, accurate, and precise in a manner that realizes battery management capabilities that are dynamic and optimized for the varying power requirements of eVTOL operations.

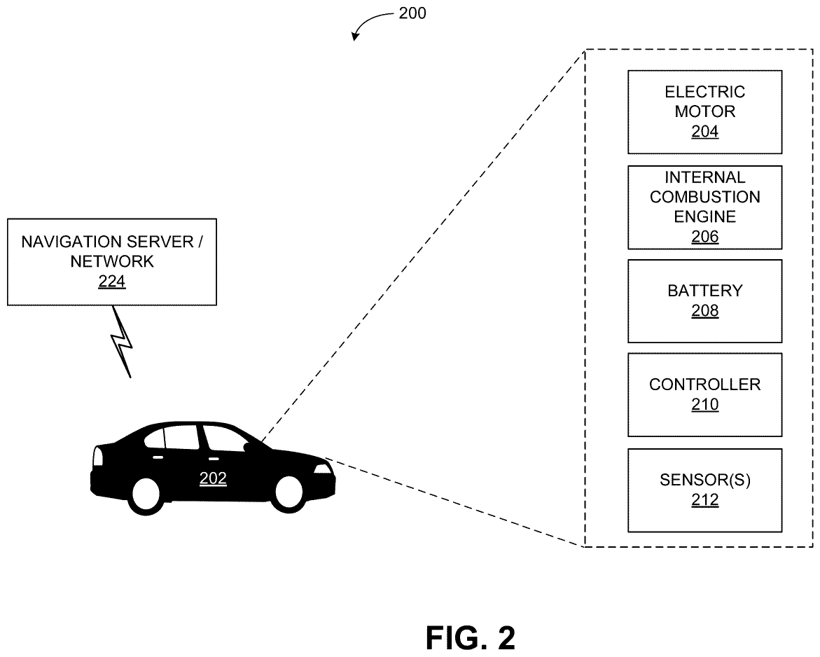

As alluded to above, various embodiments of the electric vehicle battery management system can be applied to vehicles that utilize electric motors, other than eVTOLs, which may experience operational conditions where power draw can change rapidly in a manner that lends itself to be optimized by dynamic battery management, as disclosed herein. FIG. 2 illustrates a vehicle 202, which can be a hybrid vehicle having an electric motor 204 and an internal combustion engine 206, both of which generate driving force. Furthermore, the controller 210 of the vehicle 202 can implement the electric vehicle battery management functions as described above in detail. Various types of internal combustion engines may be embodied by internal combustion engine 206, such as a gasoline or diesel engine. Various types of electric motors may be embodied by electric motor 204, such as a brushless direct current (DC) motor, an induction motor, or a DC shunt motor.

Hybrid vehicle 202 may include a battery 208 for supplying electric power to drive electric motor 204. Battery 208 may be a rechargeable battery, such as, for example, a lead-acid battery, a nickel-cadmium battery, a natrium sulphur battery, a lithium rechargeable battery, a hydrogen rechargeable battery or a redox type battery. Battery 208 may also be a mass storage condenser, or other suitable power source. It should be noted that hybrid vehicle 202 may have more than one battery, and applying pre-charge timing as described herein can be coordinated between the multiple batteries.

Although not shown, it should be understood that hybrid vehicle 202 may further comprise a battery current/voltage detection sensor for detecting electric current and voltage of battery 208. Hybrid vehicle 202 may also include a driver for changing electric current supplied from the battery 208 into an electric value to produce a predetermined torque by electric motor 204. The driver may further control regeneration current flow electric motor 204 to the battery 208. Hybrid vehicle 202 may include other un-illustrated components typically found in hybrid vehicles, such as an engine control system, a braking system/components, a steering system/components, logic components, other processors, etc.

Hybrid vehicle 202 may include a controller 210 that controls the overall operation of hybrid vehicle 202, one or more sensors 212 connected to the controller 210, and a navigation processor 220 also connected to the controller 210. Controller 210 can judge driving conditions based on various detection signals supplied from the one or more sensors 212 in order to define the driving condition of the hybrid vehicle. In some embodiments, the controller 210 can implement the RC controller and the corresponding ML model driven dynamic battery management functions described in reference to FIG. 1.

In some embodiments, controller 210 may calculate a residual charge of the battery 208 from an electric current value and voltage value of the battery 208. Accordingly, controller 210 may set a target value for the battery residual charge based on adjusted/optimized traffic conditions predictions which may be supplied to navigation system 214. In this way, the outputs of electric motor 204 and/or internal combustion engine 206 may be adjusted to bring the battery residual charge to a desired target value.

One or more sensors 212 may be used to detect operating characteristics of hybrid vehicle 202, such as speed of travel, brake actuation, acceleration, etc. An example of the one or more sensors 212 may be an accelerator pedal sensor for detecting the degree the accelerator is opened. Another example of the one or more sensors 212 may be a brake sensor for detecting the degree to which the brakes are operated. Still other examples of the one or more sensors 212 may be a shift lever sensor, a vehicle speed sensor, etc. Signals detected by the one or more sensors 212 may be supplied to the controller 210.

One or more of these operating characteristics may be utilized to determine or characterize traffic conditions experienced by hybrid vehicle 202. This in turn may reflect or be used to derive the aforementioned measured traffic conditions data. For example, if one or more sensors 212 determines hybrid vehicle 202 is traveling at a speed of, e.g., 10 kmh or less on a highway, controller 210 may determine that hybrid vehicle 202 is in a traffic jam. If the hybrid vehicle is driving on a city road, a speed of, e.g., 5 kmh or less may be considered to be indicative of a traffic jam. Information regarding the type of road or route on which hybrid vehicle 202 is traveling may be provided to controller 210 by a navigation system, e.g., navigation system 214 described in greater detail below.

One or more communications interfaces (not shown) may connect the hybrid vehicle 202 to one or more servers/networks 224. The one or more servers/networks 224 may implement the cloud-based battery management components described in reference to FIG. 1, such as training ML models depicting previously observed battery behavior of the vehicle 202 over time. In some embodiments, the one or more servers/networks 224 may provide the trained ML models to the vehicle 202 to be analyzed by the controller 210 in dynamically managing operation of the battery 208.

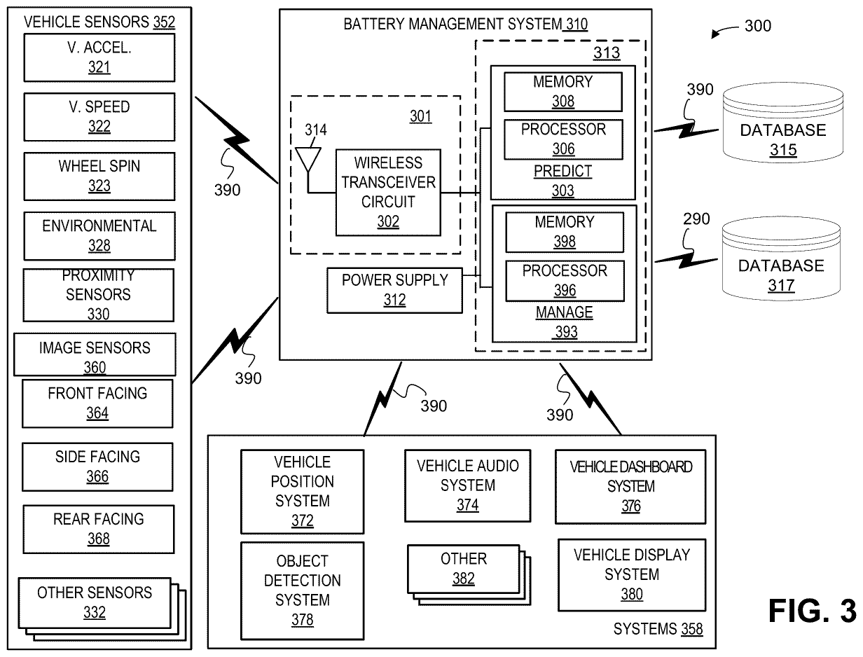

FIG. 3 depicts an example network architecture of in-vehicle electric vehicle battery management system in accordance with one embodiment of the systems and methods described herein. The vehicle 300 implementing the electric vehicle battery management system includes a battery management system circuit 310 communicatively connected to a plurality of sensors 352, a plurality of vehicle systems 358, a database 315 comprising roadway data, and a database 317. Sensors 352 and vehicle systems 358 wirelessly communicate with the battery management system circuit 310. Although in this example sensors 352 and vehicle systems 358 are depicted as communicating with the battery management system circuit 310, they can also communicate with each other as well as with other vehicle systems. The battery management system circuit 310 can be implemented as an ECU or as part of an ECU. In other embodiments, the battery management system circuit 310 can be implemented independently of the ECU.

The battery management system circuit 310 in this example includes a communication circuit 301, a controller/CPU 313 comprising a model prediction engine 303, and a battery management engine 393, and a power supply 312. Each engine includes a respective processor 306, 396 and respective memory 308, 396. For example, the model prediction engine 303 includes a processor 306, and a memory 308 configured for performing the functions associated with predicting one or more battery requirement and/or performance parameters based on ML models that are trained to learn trends in the battery's behavior over time, as described herein, and the battery management engine 393 includes a processor 396 and a memory 398 configured for performing functions associated with battery management and executing dynamic control strategies for a vehicle's battery based on the predictions made from ML models, as described herein.

Processor 306 can include one or more GPUs, CPUs, microprocessors, or any other suitable processing system. Processor 306 may include a single core or multicore processors. The memory 208 may include one or more various forms of memory or data storage (e.g., flash, RAM, etc.) that may be used to store instructions and variables for processor 306 as well as any other suitable information, such as, one or more of the following elements: rules data; resource data; GPS data; and base data, as described below. Memory 308 can be made up of one or more modules of one or more different types of memory, and may be configured to store data and other information as well as operational instructions that may be used by the processors 206 and 296.

Although the example of FIG. 3 is illustrated using processor and memory circuitry, as described below with reference to circuits disclosed herein, controller/CPU 313 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the battery management system circuit 310. Communication circuit 301 includes either or both a wireless transceiver circuit 202 with an associated antenna 314 and a wired I/O interface with an associated hardwired data port (not illustrated). Communication circuit 301 can provide for V2X communications capabilities, allowing the battery management system circuit 310 to communicate with edge devices, such as roadside equipment (RSE), network cloud servers and cloud-based databases, and/or other vehicles.

As this example illustrates, communications with the battery management system circuit 310 can include either or both wired and wireless communications circuits 301. Wireless transceiver circuit 302 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by the battery management system circuit 310 to/from other entities such as sensors 352 and vehicle systems 358.

Power supply 312 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

In the illustrated example, sensors 352 include vehicle acceleration sensors 321, vehicle speed sensors 322, wheelspin sensors 323 (e.g., one for each wheel), environmental sensors 328 (e.g., to detect salinity or other environmental conditions), proximity sensor 230 (e.g., sonar, radar, lidar or other vehicle proximity sensors), and image sensors 360. Additional sensors (i.e., other sensors 332) can be included as may be appropriate for a given implementation of the battery management system.

The sensors 352 include front facing image sensors 364, side facing image sensors 366, and/or rear facing image sensors 368. Image sensors may capture information which may be used in detecting not only vehicle conditions but also detecting conditions external to the vehicle 202 (shown in FIG. 2) as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 360 can be used to, for example, to detect objects in an environment surrounding the vehicle 302, for example, traffic signs indicating a current speed limit, road curvature, obstacles, surrounding vehicles, and so on. For example, one or more image sensors 360 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 360 may include cameras that may be used with and/or integrated with other proximity sensors 330 such as LIDAR sensors or any other sensors capable of capturing a distance. As used herein, a sensor set of a vehicle may refer to sensors 352 and image sensors 360 as a set.

Vehicle systems 358 include any of a number of different vehicle components or subsystems used to control or monitor various aspects of the vehicle and its performance. In this example, the vehicle systems 258 includes a vehicle positioning system 372; vehicle audio system 374 comprising one or more speakers configured to deliver audio throughout the vehicle; object detection system 378 to perform image processing such as object recognition and detection on images from image sensors 360, proximity estimation, for example, from image sensors 360 and/or proximity sensors, etc. for use in other vehicle systems; suspension system 380 such as, for example, an adjustable-height air suspension system, or an adjustable-damping suspension system; and other vehicle systems 382 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 372 includes a global positioning system (GPS). The vehicle 202 may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

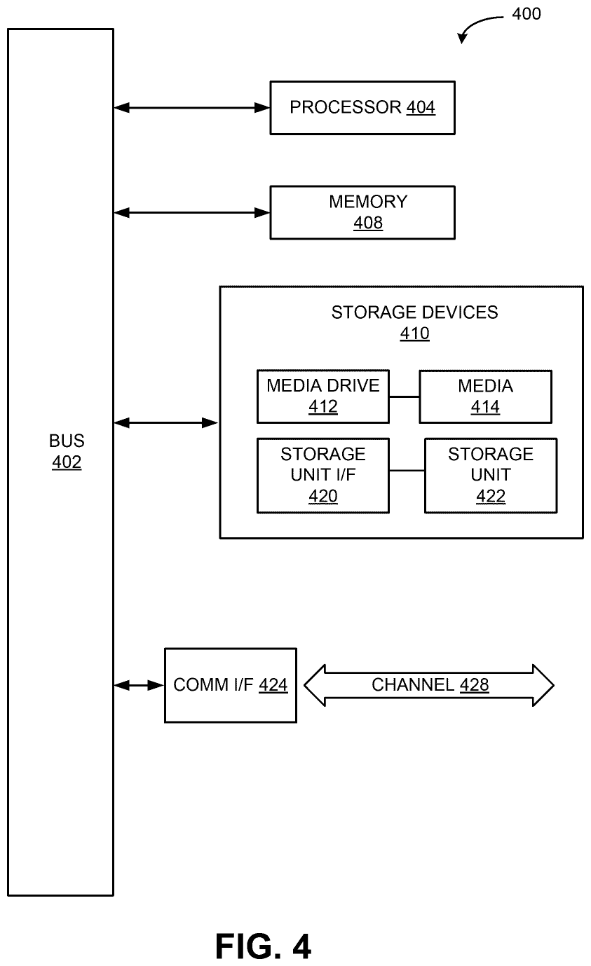

Network 390 may be a conventional type of network, wired or wireless, and may have numerous different configurations including a star configuration, token ring configuration, or other configurations. Furthermore, the network 390 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VoLTE, 5G-V2X or any other mobile data network or combination of mobile data networks. Further, the network 390 may include one or more IEEE 802.11 wireless networks.

Where components are implemented in whole or in part using software, these software elements can be implemented to operate with a computing or processing component capable of carrying out the functionality described with respect thereto. One such example computing component is shown in FIG. 4. Various embodiments are described in terms of this example-computing component 400. After reading this description, it will become apparent to a person skilled in the relevant art how to implement the application using other computing components or architectures.

Referring now to FIG. 4, computing component 400 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 400 might also represent computing capabilities embedded within or otherwise available to a given device. For example, a computing component might be found in other electronic devices such as, for example, portable computing devices, and other electronic devices that might include some form of processing capability.

Computing component 400 might include, for example, one or more processors, controllers, control components, or other processing devices. This can include a processor, and/or any one or more of the components making up controller 210 (shown in FIG. 2). Processor 404 might be implemented using a general-purpose or special-purpose processing engine such as, for example, a microprocessor, controller, or other control logic. Processor 404 may be connected to a bus 402. However, any communication medium can be used to facilitate interaction with other components of computing component 400 or to communicate externally.

Computing component 400 might also include one or more memory components, simply referred to herein as main memory 408. For example, random access memory (RAM) or other dynamic memory, might be used for storing information and instructions to be executed by processor 404. Main memory 408 might also be used for storing temporary variables or other intermediate information during execution of instructions to be executed by processor 404. Computing component 400 might likewise include a read only memory (“ROM”) or other static storage device coupled to bus 402 for storing static information and instructions for processor 404.

The computing component 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid state drive, a magnetic tape drive, an optical drive, a compact disc (CD) or digital video disc (DVD) drive (R or RW), or other removable or fixed media drive might be provided. Storage media 414 might include, for example, a hard disk, an integrated circuit assembly, magnetic tape, cartridge, optical disk, a CD or DVD. Storage media 414 may be any other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing component 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory component) and memory slot. Other examples may include a PCMCIA slot and card, and other fixed or removable storage units 422 and interfaces 420 that allow software and data to be transferred from storage unit 422 to computing component 400.

Computing component 400 might also include a communications interface 424. Communications interface 424 might be used to allow software and data to be transferred between computing component 400 and external devices. Examples of communications interface 524 might include a modem or softmodem, a network interface (such as an Ethernet, network interface card, WiMedia, IEEE 802.XX or other interface). Other examples include a communications port (such as for example, a USB port, IR port, RS232 port Bluetooth® interface, or other port), or other communications interface. Software/data transferred via communications interface 424 may be carried on signals, which can be electronic, electromagnetic (which includes optical) or other signals capable of being exchanged by a given communications interface 424. These signals might be provided to communications interface 424 via a channel 428. Channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 400 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An electric vehicle, comprising:
a battery providing electrical power for operation of the electric vehicle, wherein the operation of the electric vehicle comprises multiple phases that require a different amount of electrical power; and
one or more processors configured to:
predict one or more parameters associated with performance of the battery during the multiple phases for current operation of the electric vehicle, wherein the prediction is based on a machine learning model trained on data associated with performance of the battery during the multiple phases for previous operation of the electric vehicle; and
based on the prediction, dynamically adjust electrical power provided by the battery during one of the multiple stages for the current operation of the electric vehicle to manage the one or more parameters.

2. The electric vehicle of claim 1, wherein the electric vehicle is an electric Vertical Takeoff and Landing vehicle (eVOTL).

3. The electric vehicle of claim 2, wherein the multiple phases of operation comprise: take-off, hovering, flight, and landing.

4. The electric vehicle of claim 3, wherein the one or more parameters associated with performance of the battery comprise: electrical power output, State of Charge (SOC), State of Health (SOH), and battery temperature.

5. The electric vehicle of claim 4, wherein the one or more processors are further configured to dynamically adjust functions related to the current operation of the eVOTL in real-time based on the prediction.

6. The electric vehicle of claim 5, wherein functions related to the current operation of the eVOTL comprise: planning energy usage, optimizing flight paths for energy efficiency, battery life management, and safety operations.

7. The electric vehicle of claim 1, wherein the one or more processors are further configured to perform fast spectral initialization, delay-state concatenation and delay-state concatenation with transient states operations on the machine learning model to manage the one or more parameters associated with performance of the battery in real-time.

8. The electric vehicle of claim 7, wherein the machine learning model is trained in accordance with reservoir computing and received from a computer system remote from the electric vehicle.

9. The electric vehicle of claim 8, wherein the one or more processors are further configured to validate the trained machine learning model in real-time during the current operation of the electric vehicle.

10. Non-transitory computer readable medium comprising instructions, that when read by one or more processors, cause the one or more processors to:
predict one or more parameters associated with performance of a battery of an electric vehicle during multiple phases of current operation of the electric vehicle, wherein the battery provides electrical power for the current operation of the electric vehicle and the prediction is based on a machine learning model trained on data associated with the performance of the battery during the multiple phases for previous operation of the electric vehicle; and
based on the prediction, dynamically adjust electrical power provided by the battery during one of the multiple stages for the current operation of the electric vehicle to manage the one or more parameters.

11. The non-transitory computer readable medium of claim 10, wherein the electric vehicle is an electric Vertical Takeoff and Landing vehicle (eVOTL).

12. The non-transitory computer readable medium of claim 11, wherein the multiple phases of operation comprise: take-off, hovering, flight, and landing.

13. The non-transitory computer readable medium of claim 10, wherein the one or more parameters associated with performance of the battery comprise: electrical power output, State of Charge (SOC), State of Health (SOH), and battery temperature.

14. The non-transitory computer readable medium of claim 11, comprising further instructions, that when executed by the one or more processors, cause the one or more processors to dynamically adjust functions related to the current operation of the eVOTL in real-time based on the prediction.

15. The non-transitory computer readable medium of claim 11, wherein functions related to the current operation of the eVOTL comprise: planning energy usage, optimizing flight paths for energy efficiency, battery life management, and safety operations.

16. The non-transitory computer readable medium of claim 10, comprising further instructions, that when executed by the one or more processors, cause the one or more processors to perform fast spectral initialization, delay-state concatenation and delay-state concatenation with transient states operations on the machine learning model to manage the one or more parameters associated with performance of the battery in real-time.

17. The non-transitory computer readable medium of claim 16, wherein the machine learning model is trained in accordance with reservoir computing and received from a computer system remote from the electric vehicle.

18. The non-transitory computer readable medium of claim 17, comprising further instructions, that when executed by the one or more processors, cause the one or more processors to validate the trained machine learning model in real-time during the current operation of the electric vehicle.

19. A method comprising:
predicting one or more parameters associated with performance of a battery of an electric vehicle during multiple phases of current operation of the electric vehicle, wherein the battery provides electrical power for the current operation of the electric vehicle and the prediction is based on a machine learning model trained on data associated with the performance of the battery during the multiple phases for previous operation of the electric vehicle; and
based on the prediction, dynamically adjusting electrical power provided by the battery during one of the multiple stages for the current operation of the electric vehicle to manage the one or more parameters.

20. The method of claim 19, wherein the electric vehicle is an electric Vertical Takeoff and Landing vehicle (eVOTL).
